(19) United States
(12) Patent Application Publication
(10) Pub. No.: US 2013/0128548 A1
(43) Pub. Date: May 23, 2013

(54) COLOR FILTER ARRAY ON PIXEL ARRAY SUBSTRATE AND DISPLAY PANEL

(71) Applicant: Shiuan-Fu Lin, New Taipei City (TW)

(72) Inventor: Shiuan-Fu Lin, New Taipei City (TW)

(73) Assignee: AU OPTRONICS CORPORATION, Hsinchu (TW)

(21) Appl. No.: 13/444,801

(22) Filed: Apr. 11, 2012

(30) Foreign Application Priority Data
Nov. 17, 2011 (TW) 100142013

(51) Int. Cl. G09F 13/04; G02B 5/22

(52) U.S. Cl. 362/97.1; 359/891

(57) ABSTRACT

A color filter array on pixel array substrate includes a substrate, an active device array, a wavelength converting layer, a first passivation layer, a second passivation layer, a color filter array, and a pixel electrode layer. The active device array is disposed on the substrate. The wavelength converting layer is disposed on the active device array and includes at least one first wavelength converting pattern. The first passivation layer is disposed on the wavelength converting layer and the active device array and covers the first wavelength converting pattern and the active device array. The color filter array is disposed on the first passivation layer and includes a plurality of first, second, and third color filter patterns disposed alternately. The first wavelength converting pattern is disposed corresponding to one first color filter pattern. The second passivation layer and the pixel electrode layer are sequentially disposed on the color filter array.

### CROSS-REFERENCE TO RELATED APPLICATION

This application claims the priority benefit of Taiwan application serial no. 100142013, filed on Nov. 17, 2011. The entirety of the above-mentioned patent application is hereby incorporated by reference herein and made a part of this specification.

### BACKGROUND OF THE INVENTION

1. Field of the Invention

The invention is related to a pixel array substrate and a display panel, and in particular to a color filter array on pixel array substrate and a display panel.

2. Description of Related Art

With advantages of high definition, small volume, light weight, low driving voltage, low power consumption, and a wide range of applications, a liquid crystal display (LCD) has replaced a cathode ray tube (CRT) display and has become the mainstream display product in the next generation. The LCD is mainly composed of an LCD panel and a backlight module. The planar light source (e.g., a white light source in most cases) provided by the backlight module may perform gray-level display upon control of the LCD panel.

As to the color performance of the LCD, a color filter is often employed in the LCD panel to mix the light of the backlight module, so as to achieve color display. For instance, in an exemplary thin film transistor (TFT) LCD, the color filter corresponding to each pixel is frequently composed of red color resist, green color resist, and blue color resist. Since the dimension of each color resist and the distance between the color resists are both less than visible to a human eye, a user of a display is able to observe a display image with colors mixed by different color lights (red, green, and blue). Nonetheless, the transmittance of light varies when the light passes through each color resist of the color filter, and the varied transmittances cannot be easily increased, thus limiting the overall color adjustment flexibility of the LCD. As a result, the display color of the LCD cannot be optimized.

### SUMMARY OF THE INVENTION

The invention is directed to a color filter array on pixel array substrate where a wavelength converting layer is disposed.

The invention is further directed to a display panel with desirable display color.

In the invention, a color filter array on pixel array substrate includes a first substrate, an active device array, a wavelength converting layer, a first passivation layer, a color filter array, a second passivation layer, and a pixel electrode layer. The active device array is disposed on the first substrate. The wavelength converting layer is disposed on the active device array and includes at least one first wavelength converting pattern. The first passivation layer is disposed on the wavelength converting layer and the active device array. The color filter array is disposed on the first passivation layer and includes a plurality of first color filter patterns, a plurality of second color filter patterns, and a plurality of third color filter patterns. The first, second, and third color filter patterns are disposed alternately, and the first wavelength converting pattern is disposed corresponding to one of the first color filter patterns. The second passivation layer is disposed on the color filter array. The pixel electrode layer is disposed on the second passivation layer.

In the invention, a display panel includes a color filter array on pixel array substrate, an opposite substrate, and a display medium. In the invention, the color filter array on pixel array substrate includes a first substrate, an active device array, a wavelength converting layer, a first passivation layer, a color filter array, a second passivation layer, and a pixel electrode layer. The active device array is disposed on the first substrate. The wavelength converting layer is disposed on the active device array and includes at least one first wavelength converting pattern. The first passivation layer is disposed on the wavelength converting layer and the active device array. The color filter array is disposed on the first passivation layer and includes a plurality of first color filter patterns, a plurality of second color filter patterns, and a plurality of third color filter patterns. The first, second, and third color filter patterns are disposed alternately, and the first wavelength converting pattern is disposed corresponding to one of the first color filter patterns. The second passivation layer is disposed on the color filter array. The pixel electrode layer is disposed on the second passivation layer. The opposite substrate is located opposite to the color filter array on pixel array substrate. The display medium is located between the opposite substrate and the color filter array on pixel array substrate.

Based on the above, the wavelength converting layer is configured in the color filter array on pixel array substrate and in the display panel according to the invention. The wavelength converting layer is disposed corresponding to the color filter patterns and converts the spectrum of light before the light passes through the color filter patterns. Thereby, the transmittance of light passing through the color filter patterns can be increased. As a result, the chromaticity of the color filter array can be improved, and thereby the display panel can display images with favorable color performance.

In order to make the aforementioned and other features and advantages of the invention more comprehensible, embodiments accompanying figures are described in detail below.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the invention.

FIG. 1 is a schematic cross-sectional view illustrating a color filter array on pixel array substrate according to an embodiment of the invention.

FIG. 2 is a schematic partial cross-sectional view illustrating a display panel according to an embodiment of the invention.

FIG. 3A is a spectrum diagram illustrating that light from a backlight module passes through a red filter pattern according to experimental examples 1, 2 and a comparison example.

FIG. 3B is a spectrum diagram illustrating that light from a backlight module passes through a green filter pattern according to the experimental examples 1, 2 and the comparison example.

### DESCRIPTION OF EMBODIMENTS

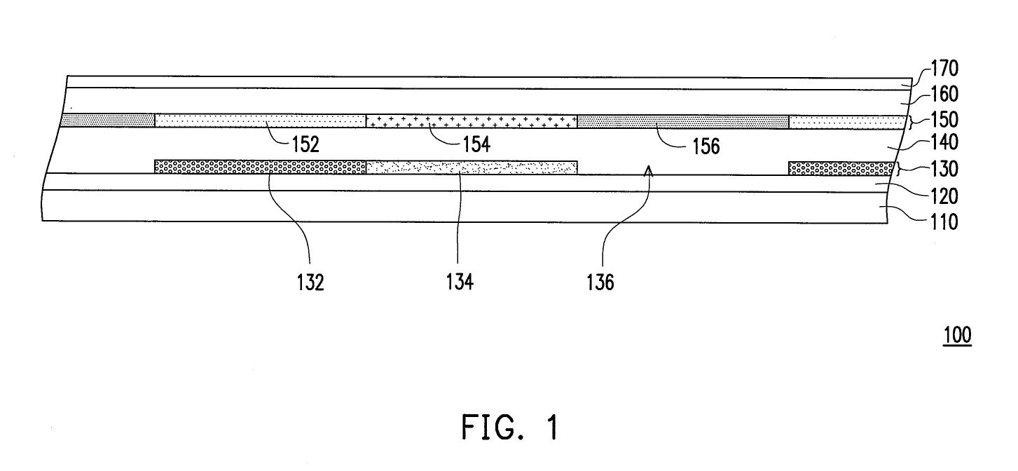

FIG. 1 is a schematic cross-sectional view illustrating a color filter array on pixel array substrate according to an embodiment of the invention. With reference to FIG. 1, a color filter array on pixel array substrate 100 includes a first substrate 110, an active device array 120, a wavelength converting layer 130, a first passivation layer 140, a color filter array 150, a second passivation layer 160, and a pixel electrode layer 170. The active device array 120 is disposed on the first substrate 110. According to the present embodiment, the first substrate 110 is a glass substrate, for instance. The active device array 120 refers to a plurality of pixel structures (not shown) configured in arrays, for instance, and each of the pixel structures exemplarily includes an active device, a scan line electrically connected to the active device, and a data line electrically connected to the active device.

The wavelength converting layer 130 is disposed on the active device array 120 and includes a plurality of first wavelength converting patterns 132 and a plurality of second wavelength converting patterns 134. In this embodiment, the wavelength converting layer 130 further includes a plurality of openings 136, each of which exposes a portion of the active device array 120. To be more specific, in this embodiment, the wavelength converting layer 130 includes a plurality of repeat units arranged in arrays, for instance, and each of the repeat units includes one of the first wavelength converting patterns 132, one of the second wavelength converting patterns 134, and one of the openings 136 sequentially in a horizontal direction. Each of the first wavelength converting patterns 132, each of the second wavelength converting patterns 134, and each of the openings 136 respectively correspond to one of the pixel structures. That is to say, one of the repeat units in the wavelength converting layer 130 corresponds to three consecutive pixel structures, for instance. The first passivation layer 140 is disposed on the wavelength converting layer 130 and the active device array 120 and covers the first wavelength converting patterns 132, the second wavelength converting patterns 134, and the active device array 120. In the present embodiment, the openings 136 are, for instance, filled with the first passivation layer 140, and the first passivation layer 140 is in contact with the active device array 120 through the openings 136. A material of the first passivation layer 140 is, for instance, silicon oxide or silicon nitride according to the present embodiment.

The color filter array 150 is disposed on the first passivation layer 140 and includes a plurality of first color filter patterns 152, a plurality of second color filter patterns 154, and a plurality of third color filter patterns 156. The first, second, and third color filter patterns 152, 154, and 156 are disposed alternately. The first wavelength converting patterns 132 are disposed corresponding to the first color filter patterns 152, and the second wavelength converting patterns 134 are disposed corresponding to the second color filter patterns 154. The third color filter patterns 156 are disposed corresponding to the openings 136 of the wavelength converting layer 130, for instance. In the present embodiment, the color filter array 150 is disposed on the first passivation layer 140, and thus the color filter array 150 is not in contact with the wavelength converting layer 130.

Here, the first color filter patterns 152 are red filter patterns, the second color filter patterns 154 are green filter patterns, and the third color filter patterns 156 are blue filter patterns, for instance. According to the present embodiment, the first wavelength converting patterns 132 convert light with a wavelength less than a first wavelength into light with a wavelength greater than the first wavelength, for instance. A material of the first wavelength converting patterns 132 includes a first wavelength converting material and resin, for instance, and an amount of the first wavelength converting material in each of the first wavelength converting patterns 132 accounts for 5% to 45%, for instance. The second wavelength converting patterns 134 convert light with a wavelength less than a second wavelength into light with a wavelength greater than the second wavelength. A material of the second wavelength converting patterns 134 includes a second wavelength converting material and resin, for instance, and an amount of the second wavelength converting material in each of the second wavelength converting patterns 134 accounts for 5% to 45%, for instance. In the present embodiment, the first wavelength converting patterns 132 exemplarily correspond to the red filter patterns, and the material of the first wavelength converting patterns 132 includes 4-(dicyanomethylene)-2-methyl-6-(p-dimethylaminostyryl)-4H-pyran (DCM), for instance. Here, the first wavelength converting patterns 132 convert light with a wavelength less than 500 nm into light with a wavelength greater than 500 nm. In the present embodiment, the second wavelength converting patterns 134 exemplarily correspond to the green filter patterns, and the material of the second wavelength converting patterns 134 includes fluorescent coumarin 30, for instance. Here, the second wavelength converting patterns 134 convert light with a wavelength less than 480 nm into light with a wavelength greater than 480 nm.

Besides, in an embodiment (not shown), when the fabrication process is taken into consideration, the first color filter patterns 152, the second color filter patterns 154, and the third color filter patterns 156 may have different heights, so as to effective resolve the color shift issue. For instance, in an embodiment of the invention, a height h_{R} of the first color filter patterns 152 is equal to a height h_{G} of the second color filter patterns 154, a height h_{B} of the third color filter patterns 156 is greater than the height h_{R} of the first color filter patterns 152, and the height h_{B} of the third color filter patterns 156 is greater than the height h_{G} of the second color filter patterns 154, for instance. In other words, a height difference ΔH_{R} between the first color filter patterns 152 and the third color filter patterns 156 is equal to a height difference ΔH_{G} between the second color filter patterns 154 and the third color filter patterns 156. Moreover, in another embodiment, a height of the first wavelength converting patterns 132 and a height of the second wavelength converting patterns 134 are respectively h″_{R} and h″_{G}, for instance; a difference between ΔH_{R} and h″_{R} may be equal to 5 um, and a difference between ΔH_{G} and h″_{G} may be equal to 5 um as well. It should be mentioned that the first wavelength converting patterns 132 and the second wavelength converting patterns 134 respectively correspond to the red filter patterns and the green filter patterns in the previous embodiment, for instance; however, in another embodiment, the wavelength converting patterns corresponding to the blue filter patterns can also be configured.

The second passivation layer 160 is disposed on the color filter array 150. A material of the second passivation layer 160 is, for instance, silicon oxide or silicon nitride. The pixel electrode layer 170 is disposed on the second passivation layer 160. A material of the pixel electrode layer 170 is indium tin oxide (ITO), for instance. According to an embodiment, the color filter array on pixel array substrate 100 further includes a light shielding pattern layer, for instance. The light shielding pattern layer may be disposed between the active device array 120 and the color filter array 150, disposed between the color filter array 150 and the pixel electrode layer 170, located on the pixel electrode layer 170, or disposed at any other appropriate location.

It should be mentioned that the wavelength converting layer 130 exemplarily has the first wavelength converting patterns 132 and the second wavelength converting patterns 134 according to the present embodiment, while the wavelength converting layer may also have only one type of wavelength converting patterns in another embodiment (not shown), and the wavelength converting patterns may correspond to the red filter patterns, the green filter patterns, or the blue filter patterns. Further, in still another embodiment (not shown), the wavelength converting layer may also have the first, second, and third wavelength converting patterns respectively corresponding to the first, second, and third color filter patterns. That is to say, in the color filter array on pixel array substrate described herein, the wavelength converting layer includes at least one wavelength converting pattern.

According to the present embodiment, the color filter array on pixel array substrate 100 includes the wavelength converting layer 130 which has the first and second wavelength converting patterns 132 and 134 respectively corresponding to the first and second color filter patterns 152 and 154. Hence, light passes through the first and second wavelength converting patterns 132 and 134 before the light enters the first and second color filter patterns 152 and 154, such that the wavelength of the light can be converted by the first and second wavelength converting patterns 132 and 134 into a wavelength that allows the light to effectively pass through the first and second color filter patterns 152 and 154. Thereby, the transmittance of light passing through the red and green color filter patterns can be significantly improved, and the overall transmittance of light passing through the color filter array can also be increased. Moreover, by means of the wavelength converting layer, white spots and color saturation can be adjusted, and the overall transmittance efficiency can be improved.

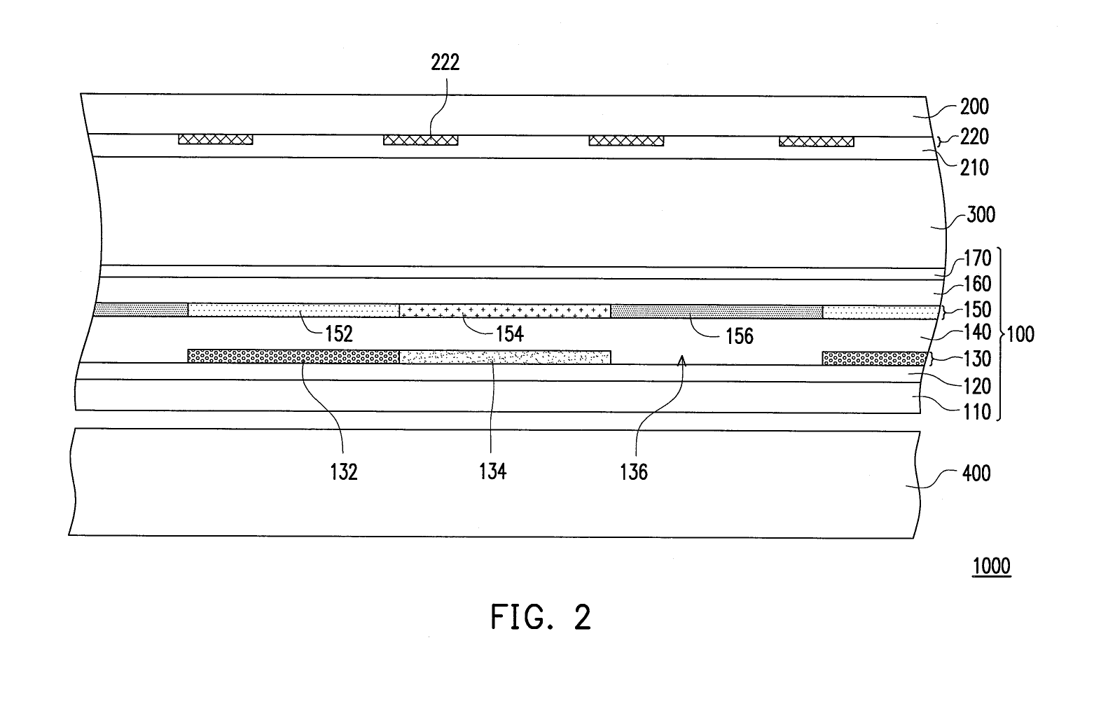

FIG. 2 is a schematic partial cross-sectional view illustrating a display panel according to an embodiment of the invention. With reference to FIG. 2, a display panel 1000 includes the color filter array on pixel array substrate 100, an opposite substrate 200, and a display medium 300. Components of the color filter array on pixel array substrate 100 can be referred to as those described in the previous embodiment and thus will not be reiterated herein. The opposite substrate 200 is located opposite to the color filter array on pixel array substrate 100. In this embodiment, the opposite substrate 200 has a common electrode 210 facing the color filter array on pixel array substrate 100. Besides, according to the present embodiment, the display panel 1000 further includes a light shielding layer 220 disposed between the opposite substrate 200 and the common electrode 210, for instance. The light shielding layer 220 exemplarily includes a plurality of light shielding patterns 222, each of which is correspondingly disposed between two of the color filter patterns 152, 154, and 156 adjacent to the light shielding pattern 222. The display medium 300 is located between the opposite substrate 200 and the color filter array on pixel array substrate 100. In this embodiment, the display medium 300 is a liquid crystal layer, for example.

According to the present embodiment, the display panel 1000 further includes a backlight module 400 disposed below the color filter array on pixel array substrate 100, for instance. Light from the backlight module 400 as the light source has a first wave peak and a second wave peak, wherein a wavelength of the first wave peak ranges from 497 nm to 552 nm, and a wavelength of the second wave peak ranges from 550 nm to 612 nm, for instance.

As described above, in the present embodiment, the wavelength converting layer 130 has the first and second wavelength converting patterns 132 and 134 respectively corresponding to the first and second color filter patterns 152 and 154. Hence, the light provided by the backlight source 400 passes through the first and second wavelength converting patterns 132 and 134 before the light enters the first and second color filter patterns 152 and 154, such that the wavelength of the light can be converted by the first and second wavelength converting patterns 132 and 134 into a wavelength that allows the light to effectively pass through the first and second color filter patterns 152 and 154. Thereby, the transmittance of light passing through the red and green color filter patterns can be significantly improved, and the overall transmittance of light passing through the color filter array can also be increased. Moreover, by means of the wavelength converting layer, white spots and color saturation can be adjusted, and the overall transmittance efficiency can be improved.

### EXPERIMENTAL EXAMPLES

To verify that the display panel described in the previous embodiments of the invention is capable of improving the transmittance of light (provided by the backlight module) passing through the red and green color filter patterns, experimental examples 1, 2, and a comparison example are provided herein for comparison. In the experimental examples 1 and 2, the display panel has the structure as shown in FIG. 2. The first wavelength converting patterns are made of DCM, and the second wavelength converting patterns are made of fluorescent coumarin 30. The first color filter patterns are red filter patterns, and the second color filter patterns are green filter patterns. The amount of the wavelength converting material in the first and second wavelength converting patterns accounts for 5% in the experimental example 1, while the amount of the wavelength converting material in the first and second wavelength converting patterns accounts for 50% in the experimental example 2. The structure of the display panel in the comparison example is similar to that of the display panel in the experimental examples. The mere difference therebetween lies in that the display panel in the comparison example is not equipped with the wavelength converting layer, while other film layers in the display panel described in the comparison example are also in the display panel described in the experimental examples.

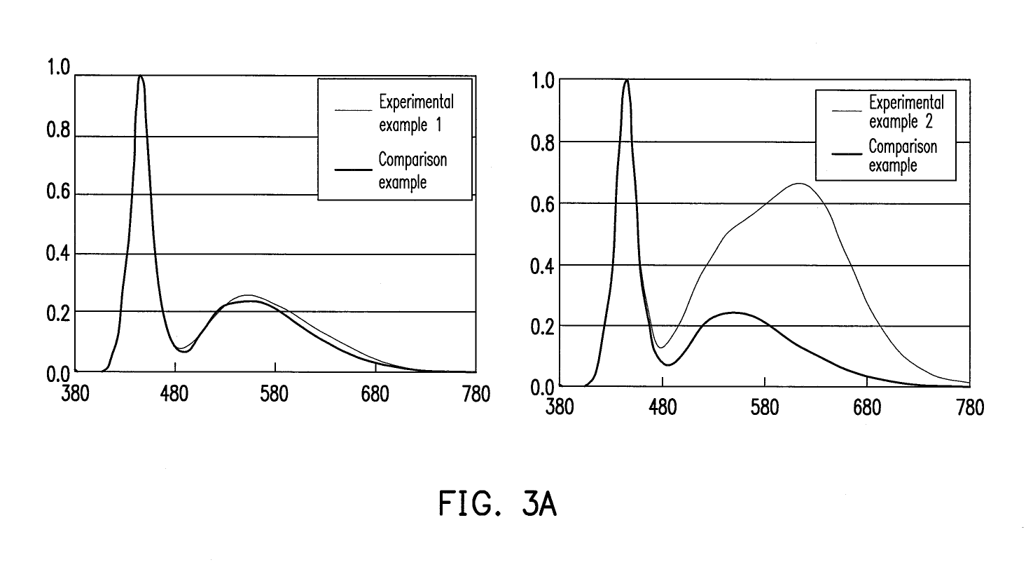

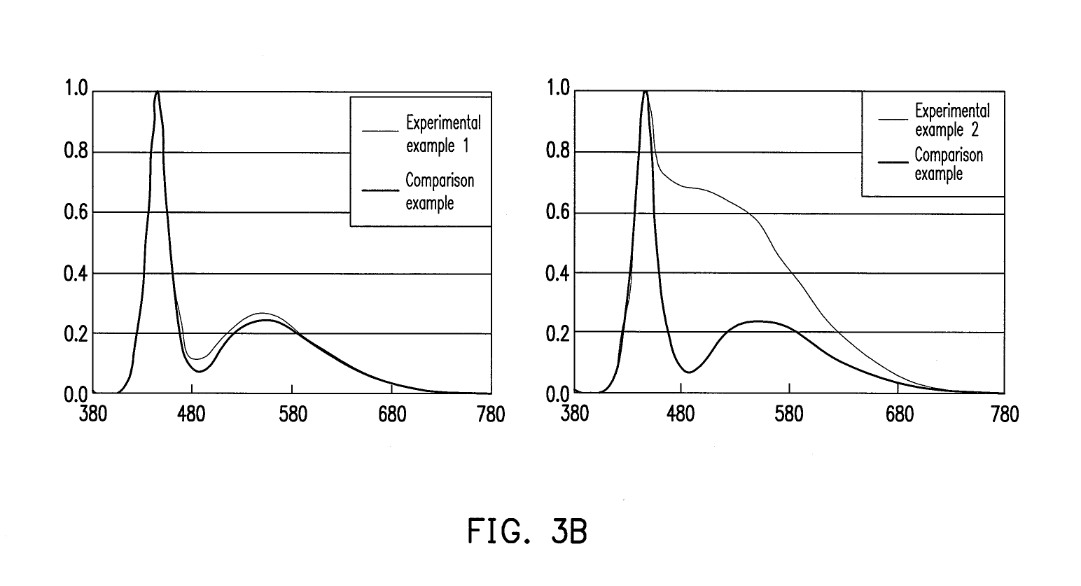

FIG. 3A is a spectrum diagram illustrating that light from a backlight module passes through red filter patterns according to experimental examples 1, 2 and a comparison example. FIG. 3B is a spectrum diagram illustrating that light from a backlight module passes through green filter patterns according to the experimental examples 1, 2 and the comparison example. It can be learned from FIG. 3A and FIG. 3B that the spectrum of light in the experimental example 2 is obviously shifted in comparison with the spectrum of light in the experimental example 1 and that in the comparison example. Specifically, as to the red filter patterns, the spectrum is shifted from the wavelength of 551˜558 to the wavelength of 611˜615; as to the green filter patterns, the spectrum is shifted from the wavelength of 551˜558 to the wavelength of 487˜489. Accordingly, when the amount of the wavelength converting material in the wavelength converting patterns accounts for greater than 5%, the wavelength of light can be effectively converted into a wavelength of light characterized by a better transmittance to the color filter patterns.

In another experimental example, the same experimental conditions as those in the experimental examples 1 and 2 are also applied, while the wavelength converting patterns in which the amount of the wavelength converting material respectively accounts for 5%, 10%, 20%, 30%, 35%, 40%, 45%, and 50% are applied to measure the transmittance of light passing through the red color patterns in the color filter array, the transmittance of light passing through the green color patterns in the color filter array, the overall transmittance in the color filter array, and the chromaticity of the color filter array. According to the experimental results, the wavelength converting patterns with certain amount of wavelength converting material as described above allow the transmittance of light passing through the red filter patterns to be improved by 10.3%, 19.9%, 37.4%, 53.0%, 60.2%, 67.1%, 73.6%, and 79.8%, respectively; allow the transmittance of light passing through the green filter patterns to be improved by 0.9%, 1.6%, 3.0%, 4.2%, 4.7%, 5.2%, 5.7%, and 6.1%, respectively; allow the overall transmittance of light be improved by 2.0%, 3.8%, 7.2%, 10.1%, 11.5%, 12.8%, 14.0%, and 15.1%. Furthermore, the chromaticity is measured under the NTSC standard: when the amount of the wavelength converting material accounts for 0%, and the NTSC % in the comparison example is 73.1%, the NTSC % in the experimental example are 75.0%, 76.6%, 78.9%, 80.7%, 81.5%, 82.1%, 82.7%, and 83.3%, respectively. By contrast, the chromaticity may be measured under the sRGB standard: when the amount of the wavelength converting material accounts for 0%, and the sRGB % in the comparison example is 96.2%, the sRGB % in the experimental example are 98.3%, 99.3%, 99.7%, 99.8%, 99.8%, 99.8%, 99.8%, and 99.6%, respectively. The overall efficiency is improved by 1.5%, 2.8%, 5.3%, 7.5%, 8.6%, 9.5%, 10.5%, and 11.4%, respectively. In the sRGB experiment, the chromaticity of the color filter array slightly decreases when the amount of the wavelength converting material accounts for 50%, and thus the amount of the wavelength converting material preferably accounts for 5%˜45%. As provided above, the wavelength converting layer can significantly improve the transmittance of light passing through the red and green color filter patterns, and the overall transmittance of light passing through the color filter array can also be increased by the wavelength converting layer; namely, the more the wavelength converting material, the broader the chromatic range. Additionally, by means of the wavelength converting layer, white spots and color saturation can be adjusted, and the overall transmittance efficiency can be improved.

In view of the above, according to an embodiment of the invention, the wavelength converting layer in the display panel and in the color filter array on pixel array substrate has the first and second wavelength converting patterns respectively corresponding to the first and second color filter patterns. Hence, the light provided by the backlight source passes through the first and second wavelength converting patterns before the light enters the first and second color filter patterns, such that the wavelength of light can be converted by the first and second wavelength converting patterns into a wavelength that allows the light to effectively pass through the first and second color filter patterns. Thereby, the transmittance of light passing through the red and green color filter patterns can be significantly improved, and the overall transmittance of light passing through the color filter array can also be increased. Moreover, by means of the wavelength converting layer, white spots and color saturation can be adjusted, and the overall transmittance efficiency can be improved. As a result, the color filter array on pixel array substrate as described herein has favorable chromaticity, and the display panel in which the pixel array substrate is applied has favorable display color.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A color filter array on pixel array substrate, comprising:
a first substrate;
an active device array disposed on the first substrate;
a wavelength converting layer disposed on the active device array and comprising at least one first wavelength converting pattern;
a first passivation layer disposed on the wavelength converting layer and the active device array;
a color filter array disposed on the first passivation layer and comprising a plurality of first color filter patterns, a plurality of second color filter patterns, and a plurality of third color filter patterns, the first, second, and third color filter patterns being disposed alternately, wherein the at least one first wavelength converting pattern is disposed corresponding to one of the first color filter patterns;
a second passivation layer disposed on the color filter array; and
a pixel electrode layer disposed on the second passivation layer.

2. The color filter array on pixel array substrate as recited in claim 1, wherein the first color filter patterns, the second color filter patterns, and the third color filter patterns respectively comprise a plurality of red filter patterns, a plurality of green filter patterns, and a plurality of blue filter patterns.

3. The color filter array on pixel array substrate as recited in claim 1, wherein each of the at least one first wavelength converting pattern comprises a first wavelength converting material, and an amount of the first wavelength converting material in the at least one first wavelength converting pattern accounts for 5% to 45%.

4. The color filter array on pixel array substrate as recited in claim 1, wherein the wavelength converting layer further comprises at least one second wavelength converting pattern, and one of the second color filter patterns is disposed corresponding to the at least one second wavelength converting pattern.

5. The color filter array on pixel array substrate as recited in claim 4, wherein the first passivation layer covers the at least one second wavelength converting pattern.

6. The color filter array on pixel array substrate as recited in claim 4, wherein the at least one second wavelength converting pattern comprises a second wavelength converting material, and an amount of the second wavelength converting material in the at least one second wavelength converting pattern accounts for 5% to 45%.

7. The color filter array on pixel array substrate as recited in claim 1, wherein the wavelength converting layer comprises a plurality of openings, and each of the openings exposes a portion of the active device array.

8. The color filter array on pixel array substrate as recited in claim 7, wherein the openings correspond to the third color filter patterns.

9. The color filter array on pixel array substrate as recited in claim 7, wherein the openings are substantially filled with the first passivation layer.

10. A display panel comprising:
a color filter array on pixel array substrate, comprising:
a first substrate;
an active device array disposed on the first substrate;
a wavelength converting layer disposed on the active device array and comprising at least one first wavelength converting pattern;
a first passivation layer disposed on the wavelength converting layer and the active device array;
a color filter array disposed on the first passivation layer and comprising a plurality of first color filter patterns, a plurality of second color filter patterns, and a plurality of third color filter patterns, the first, second, and third color filter patterns being disposed alternately, wherein the at least one first wavelength converting pattern is disposed corresponding to one of the first color filter patterns;
a second passivation layer disposed on the color filter array; and
a pixel electrode layer disposed on the second passivation layer;
an opposite substrate located opposite to the color filter array on pixel array substrate; and
a display medium located between the opposite substrate and the color filter array on pixel array substrate.

11. The display panel as recited in claim 10, wherein the first color filter patterns, the second color filter patterns, and the third color filter patterns respectively comprise a plurality of red filter patterns, a plurality of green filter patterns, and a plurality of blue filter patterns.

12. The display panel as recited in claim 10, wherein each of the at least one first wavelength converting pattern comprises a first wavelength converting material, and an amount of the first wavelength converting material in the at least one first wavelength converting pattern accounts for 5% to 45%.

13. The display panel as recited in claim 10, wherein the wavelength converting layer further comprises at least one second wavelength converting pattern.

14. The display panel as recited in claim 13, wherein one of the second color filter patterns is disposed corresponding to the at least one second wavelength converting pattern.

15. The display panel as recited in claim 13, wherein the first passivation layer covers the at least one second wavelength converting pattern.

16. The display panel as recited in claim 13, wherein the at least one second wavelength converting pattern comprises a second wavelength converting material, and an amount of the second wavelength converting material in the at least one second wavelength converting pattern accounts for 5% to 45%.

17. The display panel as recited in claim 10, wherein the wavelength converting layer comprises a plurality of openings, and each of the openings exposes a portion of the active device array.

18. The display panel as recited in claim 17, wherein the openings correspond to the third color filter patterns.

19. The display panel as recited in claim 17, wherein the openings are substantially filled with the first passivation layer.

20. The display panel as recited in claim 10 further comprising a backlight module disposed below the color filter array on pixel array substrate, a light source supplied by the backlight module having a first wave peak and a second wave peak, wherein a wavelength of the first wave peak ranges from 497 nm to 552 nm, and a wavelength of the second wave peak ranges from 550 nm to 612 nm.
